(19) United States
(12) Patent Application Publication
(10) Pub. No.: US 2010/0257574 A1
(43) Pub. Date: Oct. 7, 2010

(54) Multimedia network splitter

(76) Inventors: Chun-Hsien Pan, Tainan City (TW); Hsin-Lung Huang, Gueiren Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/385,181

(22) Filed: Apr. 1, 2009

(51) Int. Cl. H04N 7/173

(52) U.S. Cl. 725/127

(57) ABSTRACT

This invention relates to a multimedia network splitter in which a plurality of connection terminals are provided at the outer edge of the housing and a circuit board is provided in the interior of the housing. Corresponding to the connection terminals on the housing, a plurality of radially spaced attenuation circuits are provided on the circuit board. Each attenuation circuit is composed of a first resistor and a second resistor in parallel connection together, and each attenuation circuit is suitably matched on the circuit board. With this structure, after the connection terminals are connected with a plurality of televisions or a variety of digital multimedia equipments by coaxial cables, better flatness of frequency bandwidth and wider extended bandwidth can be obtained during transmission of various signals in upload or download condition such that the signals can be evenly distributed among the networks linked between the terminals in use. Furthermore, the insertion loss, i.e., the attenuation value can be adjusted according to demand, and better return loss feature is obtained so as to reach more stable signal distribution and anti-interference characteristics. Therefore, the convenience in its total practical application is enhanced.

### BACKGROUND OF THE INVENTION

1. Field of the Invention

This invention relates to a multimedia network splitter, particularly to a novel multimedia network splitter having better flatness in higher frequency extension during duplex signal transmission such that the insertion loss can be adjusted according to demand, and better return loss feature can be obtained so as to reach more stable signal distribution and anti-interference characteristics, hence the convenience in its total practical application is enhanced when the multimedia network splitter is used to connect with a plurality of televisions or a variety of digital multimedia equipments.

2. Brief Description of Prior Art

The development of combining digital product with digital multimedia equipment is becoming the future trend of home networking. In addition to the WLAN (wireless local area network), the home network connection technology under developing comprises networking technologies of ultra wide band (UWB), HomePlug and MoCA (Multimedia over Coax Alliance) etc. Among those technologies mentioned above, the networking technology of MoCA is a technology alliance founded by a plurality of cable TV companies, satellite TV companies, network equipment suppliers on January 2004. The MoCA is active to facilitate and promote home networking by coaxial cable for home-use so as to connect TV, digital multimedia equipments together for duplex multimedia file transmission and application services. The goal is to integrate telephone, network, CATV, SMATV (Satellite Master Antenna Television System), and WLAN etc. into a coaxial cable through the networking technologies developed by MoCA so as to further upgrade practical application convenience and effectiveness in daily life of human.

The above networking technology developed by MoCA can reach expected effectiveness of integrating telephone, network, CATV, SMATV (Satellite Master Antenna Television System), and WLAN etc. into a coaxial cable, however it is found in practical application that various signals transmitted through coaxial cable have selective attenuation in the frequency of its return signal during the duplex signal transmission process, after various signals are inputted into a plurality of televisions or a variety of multimedia equipments connected to the multimedia broadband splitter of user end. In other words, the attenuation value is not the same for different frequency such that the flatness of frequency extending to higher frequency is not that good. This will result in instability of signal distribution and liability to interference. Instability of signal distribution and interference become more apparent especially in mansion where a mass of residents exists and a huge amount of televisions and various digital multimedia equipments are connected therein. Consequently, the application of MoCA is still unsatisfactory and hence improvements are anxiously expected.

In view of the above facts, inventor of the present invention provides a novel multimedia network splitter according to the improvement conducted on defects of the existing structure based on his abundant experience of R&D and manufacturing in relevant field so as to attain better performance in practical application.

### SUMMARY OF THE INVENTION

In order to achieve the above object, this invention provides a multimedia network splitter in which a plurality of connection terminals are provided at the outer edge of the housing and a circuit board is provided in the interior; corresponding to the connection terminals on the housing, a plurality of radially spaced attenuation circuits being provided on the circuit board, which is composed of a first resistor and a second resistor parallelly connected together, and each attenuation circuit being suitably matched on the circuit board. With this structure, after the connection terminals are connected with a plurality of televisions or a variety of digital multimedia equipments by coaxial cables, better flatness of frequency bandwidth and wider extended bandwidth can be obtained during transmission of various signals in upload or download condition such that the signals can be evenly distributed among the networks linked between the terminals in use. Furthermore, the insertion loss, i.e., the attenuation value can be adjusted according to demand, and better return loss feature is obtained so as to reach more stable signal distribution and anti-interference characteristic. Therefore, the convenience in its total practical application is enhanced.

### BRIEF DESCRIPTION OF THE DRAWINGS

The present invention will be better understood by referring to the accompanying drawings, wherein:

FIG. 1 is a perspective schematic view showing the appearance of the multimedia network splitter of the present invention.

FIG. 2 is a schematic view showing the structural arrangement of the circuit board of the present invention.

FIG. 3 is a circuit diagram of the multimedia network splitter of the present invention.

FIG. 4 is a characteristic curve showing the insertion loss of signal of the present invention.

FIG. 5 is a characteristic curve showing the return loss of signal of the present invention.

### DETAILED DESCRIPTION OF THE PREFERRED EMBODIMENTS

The objects, the technical contents and the expected effectiveness of the present invention will become more apparent from the detailed description of the preferred embodiment in conjunction with the accompanying drawings.

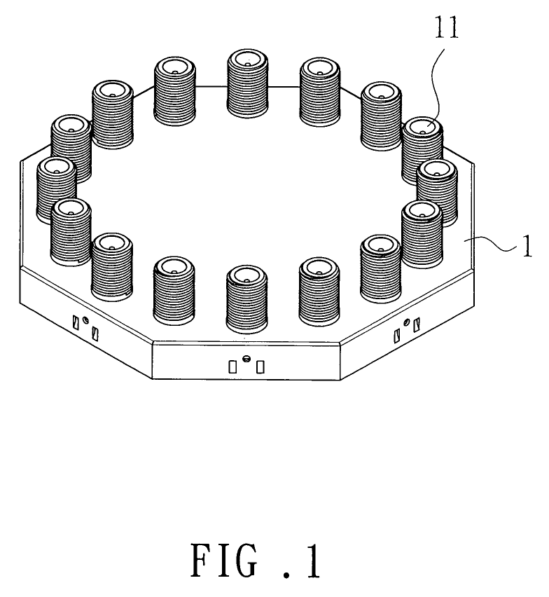

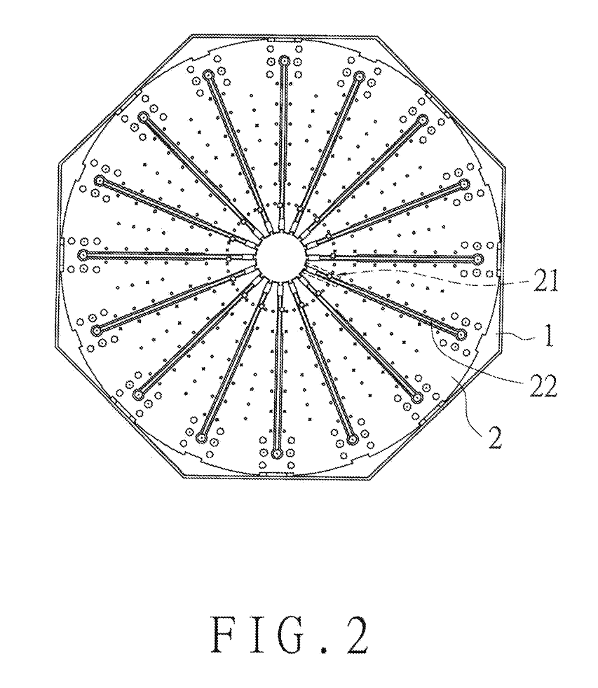

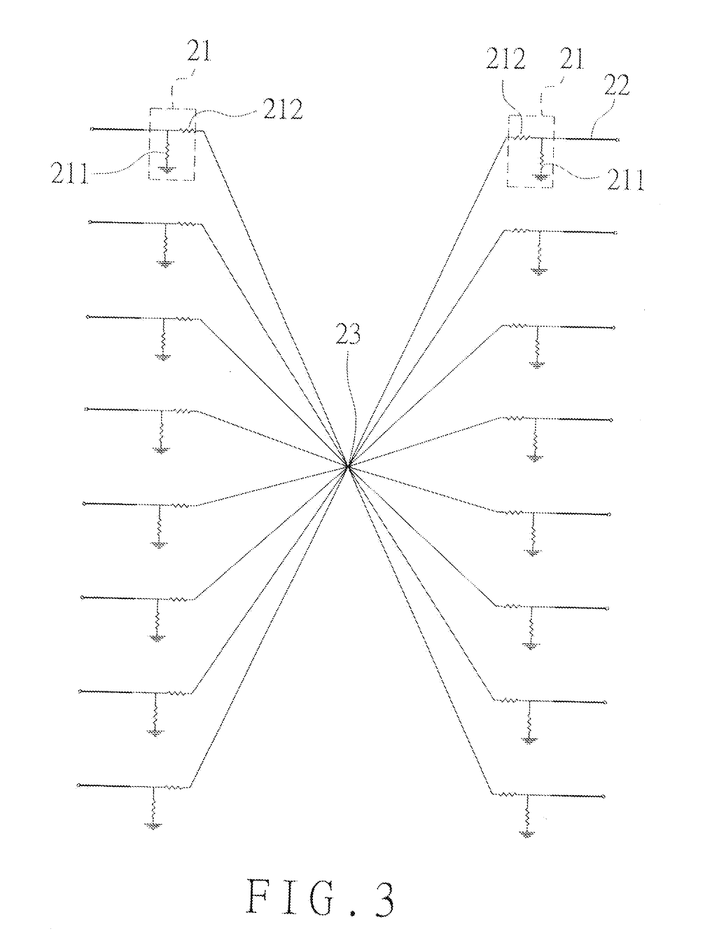

FIG. 1 is a perspective schematic view showing the appearance of the multimedia network splitter of the present invention, and FIG. 2 is a schematic view showing the structural arrangement of the circuit board of the present invention. Firstly referring to FIG. 1, the multimedia network splitter of the present invention has a housing (1); a plurality of connection terminals (11) being provided at the outer edge of the housing (1) and a circuit board (2) being provided in the interior of the housing (1). Corresponding to the connection terminals (11) on the housing (1), a plurality of equally spaced and radially directed attenuation circuits (21) are provided on the circuit board (2), each of which is composed of a first resistor (211) and a second resistor (212) in parallel connection together as shown in FIG. 3 showing the circuit diagram of the present invention. The common end of the first resistor (211) and the second resistor (212) in each attenuation circuit (21) is connected by a microstrip (22) to the corresponding connection terminal (11) on the housing (1). The other end of the first resistor (211) is connected to ground, while the other end of the second resistor (212) is connected with the second resistor (212) of the other attenuation circuit (21) together to the center node (23) of the circuit board (2). Each attenuation circuit (21) is to be suitably matched on the circuit board (2), and the impedance value of the first resistor (211) of each attenuation circuit (21) is made to be identical as the others and so is the impedance value of the second resistor (212) such that the desired bandwidth can be reached by adjusting the impedance values of the first resistor (211) and the second resistor (212).

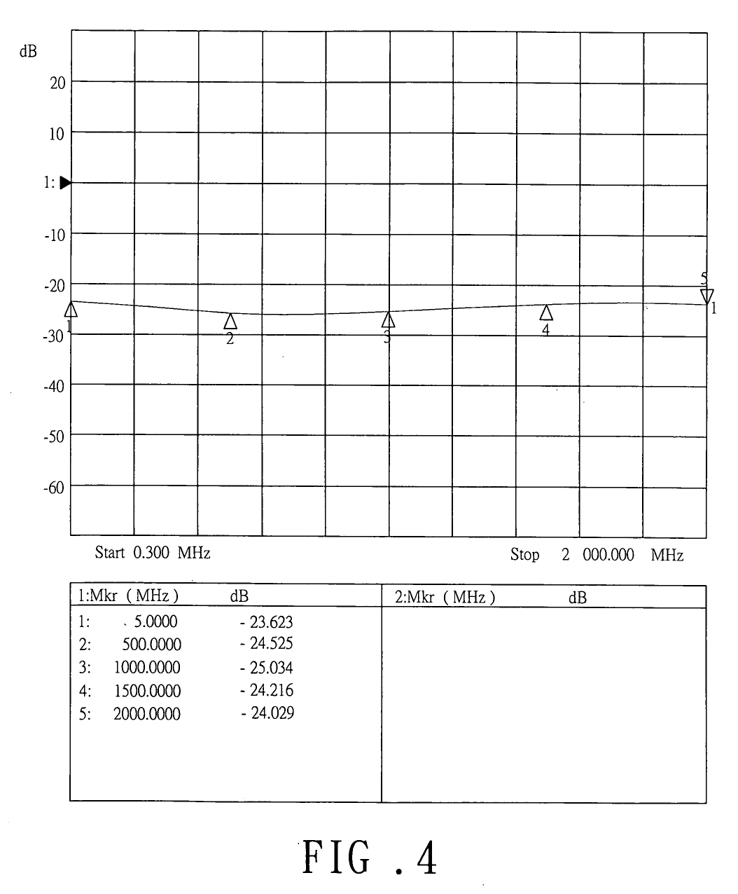

With this structure, after the connection terminals (11) are connected by coaxial cables to a plurality of televisions or a variety of digital multimedia equipments, the signal characteristic measured by each connection terminal (11) is inspected by RF Network Analyzer. As shown in FIG. 4 which is a characteristic curve showing the insertion loss of signal of the present invention, the Meas1, in the segment starting from 0.3 MHz to 2000 MHz in the X-axis direction representing the bandwidth, is respectively: −23.623 db at Mkr1 of 5 MHz, −24.525 db at Mkr2 of 500 MHz, −25.034 db at MKr3 of 1000 MHz, −24.216 db at Mkr4 of 1500 MHz, −24.029 db at Mkr5 of 2000 MHz, such that the insertion loss can be adjusted according to demand, i.e., the attenuation value is adjustable. Moreover, the curve is relatively flat, i.e., excellent characteristic curve can still be obtained at higher frequency. Thus, more stable signal distribution and anti-interference features can be obtained in duplex signal transmission.

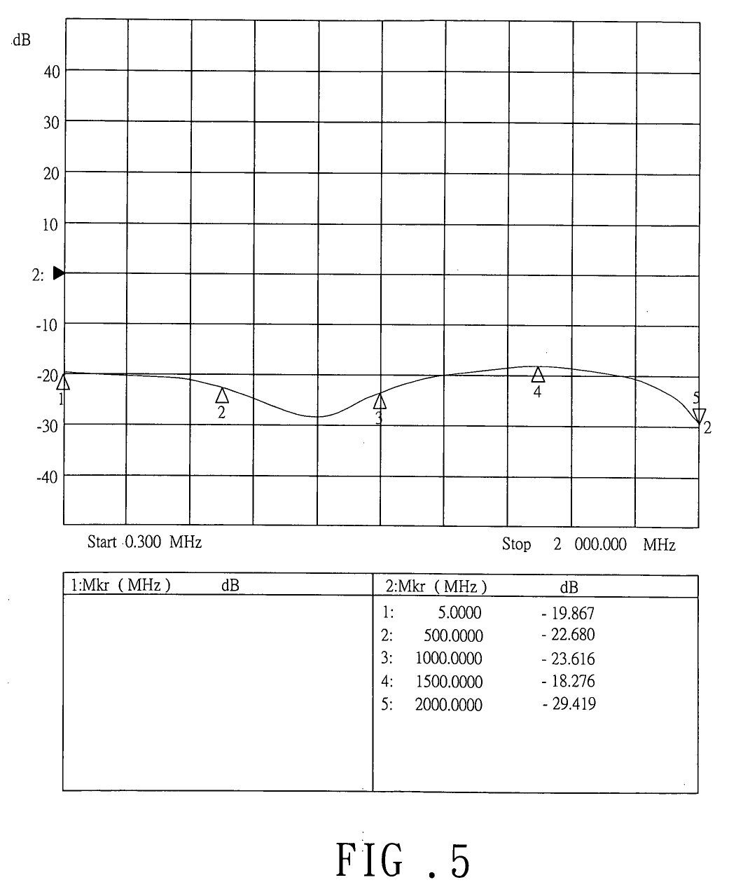

Further, referring to FIG. 5 showing the characteristic curve of return loss of signal of the present invention, the Meas2 is respectively: −19.867 db at Mkr1 of 5 MHz, −22.680 db at Mkr2 of 500 MHz, −23.616 db at MKr3 of 1000 MHz, −18.276 db at Mkr4 of 1500 MHz, −29.419 db at Mkr5 of 2000 MHz, i.e., the return loss at eat Mrk point is below −18 db. This means that the present invention has excellent return loss characteristic value.

The abovementioned embodiment and drawings are not used to limit of the scope of the present invention. Equivalent variations and modifications made by the person skilled in the art without departing from the spirit and scope of the present invention are still considered to be further embodiments of the present invention.

Based on the foregoing, the multimedia network splitter of the present invention has the following advantages when comparing with the structure of conventional stuff.
1. Inasmuch as the present invention has a plurality of connection terminals provided on the housing and the connection terminals are connected with attenuation circuits which are formed by two resistors in parallel connection and are connected to form a radially spaced arrangement after suitable matching, after the connection terminals are connected with a plurality of televisions or a variety of digital multimedia equipments by coaxial cables, better flatness of frequency bandwidth and wider extended bandwidth can be obtained such that the signals can be evenly distributed among the networks linked between the terminals in use. Furthermore, the insertion loss, i.e., the attenuation value can be adjusted according to demand, and better return loss feature is obtained so as to reach more stable signal distribution and anti-interference characteristics during duplex signal transmission. Therefore, the convenience in its total practical application is enhanced.
2. The present invention has a plurality of connection terminals provided on the housing such that after the connection of one of the connection terminals to the coaxial cable of server end, the rest of the connection terminals are connected respectively to a plurality of televisions or a variety of digital multimedia equipments of server end. This can avoid signal distortion during duplex signal transmission caused by using a number of splitters for the connection to a plurality of televisions or a variety of digital multimedia equipments. Especially in the case of mansion having a mass of residence, each client premise equipment can connected to each connection terminal simultaneously without the need of passing through a number of splitters as prior art so that signal distortion can be effectively prevented during duplex signal transmission.

Summing up above, the embodiment of the multimedia network splitter of this invention can reach expected effectiveness, and the specific configurations disclosed herein have yet not seen in the prior art of the same category of product, even has not been opened to the public before application.

What is claimed is:

1. A multimedia network splitter, wherein said multimedia network splitter has a plurality of radially spaced attenuation circuits provided on a circuit board, each said attenuation circuit being formed by a first resistor and a second resistor in parallel connection together in which said first resistor is connected to ground, the other end of said second resistor being connected with the second resistor of the other attenuation circuit, the impedance value of said first resistor of each attenuation circuit being set as equal, so being the impedance value of said second resistor.

2. A multimedia network splitter as claimed in claim 1, wherein the attenuation circuits are equally spaced on the circuit board in a radial manner.

3. A multimedia network splitter, wherein said multimedia network splitter has a housing; a plurality of connection terminals being provided at the outer edge of the housing and a circuit board being provided in the interior of the housing; corresponding to the connection terminals on the housing, a plurality of radially spaced attenuation circuits being provided on the circuit board, each of which is composed of a first resistor and a second resistor in parallel connection together; the common end of said first resistor and said second resistor in each attenuation circuit being connected by a microstrip to the corresponding connection terminal on said housing; the other end of said first resistor being connected to ground, while the other end of said second resistor being connected with the second resistor of the other attenuation circuit together to the center node of said circuit board; each attenuation circuit being suitably matched on said circuit board, and the impedance value of said first resistor of each attenuation circuit being made to be identical as the others and so being the impedance value of said second resistor such that the desired bandwidth can be reached by adjusting the impedance values of said first resistor and said second resistor.

4. A multimedia network splitter as claimed in claim 3, wherein the attenuation circuits are equally spaced on the circuit board in a radial manner.
